(19) United States
(12) Patent Application Publication
(10) Pub. No.: US 2010/0175725 A1
(43) Pub. Date: Jul. 15, 2010

(54) SYSTEM CONSTRUCTION KIT FOR INNER CONTAINERS OF DISHWASHERS

(75) Inventors: Michael Rosenbauer, Reimlingen (DE); Bernd Schessl, Dillingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/667,695

(22) PCT Filed: Jun. 25, 2008
(86) PCT No.: PCT/EP08/58086

§ 371 Date: Jan. 5, 2010

(30) Foreign Application Priority Data
Jul. 6, 2007 (DE) 10 2007 031 478.9

(51) Int. Cl. A47L 15/00; F16B 1/00; B23P 17/04

(52) U.S. Cl. 134/115 R; 403/179; 29/428

(57) ABSTRACT

A method for connecting at least two components that are made of the same material or a different material at least in connection regions of the two components. The two components are provided with at least one interface to connect the same materials or the different materials, and the two components are brought together and connected.

The invention relates to a method for connecting at least two components, in particular of a base element to a container jacket, in particular for a dishwasher, in which method the at least two components to be connected are made of the same or different material(s) at least in connection regions of the at least two components. The invention also relates to a component, which has at least one interface for connection to a further component and a water-bearing domestic appliance, in particular a dishwasher, which has been manufactured according to the inventive method and/or has an inventive component.

Water-bearing domestic appliances, such as domestic dishwashers for example, are produced either as a structure made completely of stainless steel, a structure made completely of plastic or as a composite construction with a plastic base. A structure made completely of stainless steel, a structure made completely of plastic or a composite construction with a plastic base here refers to a dishwasher inner container, which is formed from a base element, for example a base trough, and a container jacket, the container jacket forming the inner wash chamber, while electrical components such as wash liquor and circulation pumps as well as softening facilities among other things are disposed in the base trough.

The currently known structures made completely of stainless steel, structures made completely of plastic or composite constructions with plastic however do not permit different material combinations to be used, particularly with a base structure relating to all the base components such as circulation and wash liquor pumps for example, so that the current structures made completely of stainless steel, structures made completely of plastic and composite constructions with a plastic base require a production line to be kept available for each of said structures. This increases logistics outlay and also reduces the capacity for responding in a flexible manner to demand fluctuations.

The object of the invention is therefore to remedy this and allow the above-mentioned structures to be produced using a base platform.

This invention is achieved by a method for connecting at least two components, in particular of a base element to a container jacket, in particular for a dishwasher, in which method the at least two components to be connected are made of the same or different material(s) at least in connection regions of the at least two components, with the following steps:
providing the components to be connected with at least one interface, which is designed both to connect the same material and to connect different materials,
bringing the components together and
connecting the components.

This method allows a dishwasher inner container, consisting of a base trough forming a base element and a container jacket, to be joined together, when both the base element and the container jacket are made of the same or different materials. The base element or container jacket here can be made of metal, for example stainless steel, or of plastic. This method can also be used to connect two components, of which one or both components is/are made not only of one material but of a number of materials, in other words is/are formed in sections of at least two different materials, e.g. metal/plastic or even different metals.

By providing the components to be connected with at least one interface, which is designed both to connect the same material and to connect different materials, it is possible to connect both homogeneous material combinations, e.g. stainless steel/stainless steel and plastic/plastic and heterogeneous material combinations, e.g. plastic/stainless steel, to one another, the provision of the component to be connected with an interface, which is designed to establish a connection of at least two connecting techniques, allowing one base structure to be used for different structures such as a structure made completely of stainless steel, a structure made completely of plastic or a composite construction with a plastic base.

Provision is preferably made here for at least one interface to be designed to connect the components without connecting elements. This advantageously means that the interfaces disposed in the connection region of the at least two components are not weakened for example by the introduction of holes, thereby ensuring maximum mechanical stability.

In one preferred development of the method provision is made for the at least one interface to be designed to establish a material fit between the components. This can be done for example by soldering, welding or even pressing.

However provision is preferably made for at least one interface to be designed to establish a bonded connection between the components, so that the joint sites can be sealed at the same time using a low-cost method. This method is particularly suitable for connecting two components, when these are both made of plastic or one component is made of plastic and the second component is made of metal.

In a further advantageous development of the inventive method provision is made for at least one interface to be designed to establish a form fit between the components. For example the at least one interface can be designed as a snap-fit connection.

In a further advantageous development of the inventive method provision is made for at least one interface to be designed to establish a folded connection between the components. The design of the at least one interface to establish a folded connection in particular allows the connection of two components made of stainless steel.

The base element here can in particular be provided with an interface to establish a folded connection, which at the same time forms a groove, into which a strand of bonding agent can be introduced to establish a bonded connection between two components to be connected.

The invention also relates to a component, which is designed to implement the method and at least one interface for connection to a further component, the at least one interface being designed to establish a connection to a further component made of the same or different materials.

Finally the invention also relates to a water-bearing domestic appliance, in particular a domestic dishwasher, which is manufactured according to the inventive method and/or has an inventive component.

The invention is described below with reference to a drawing, in which:

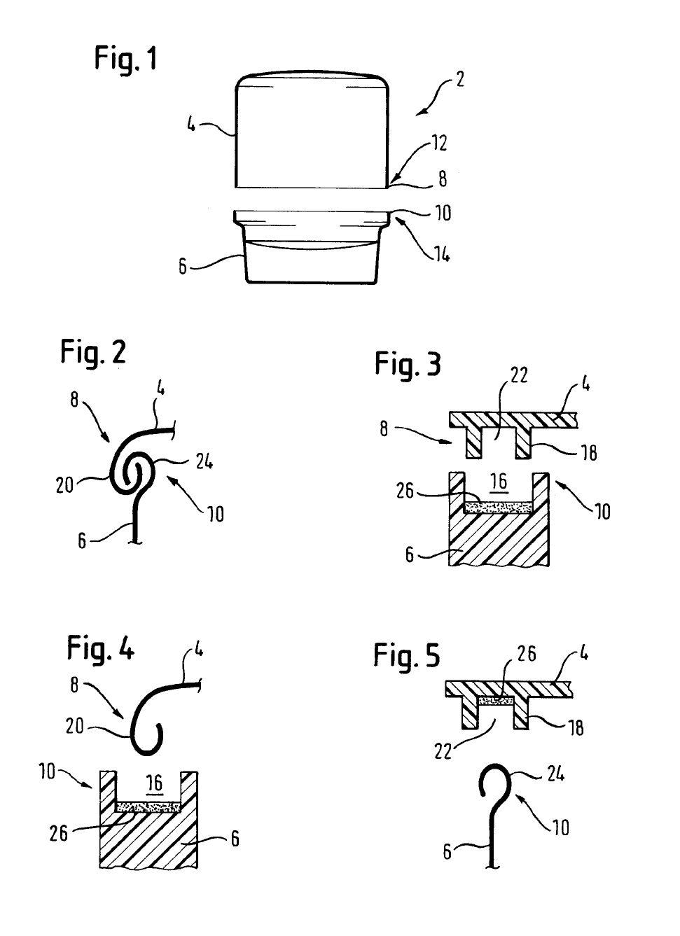

FIG. 1 shows a schematic diagram of two components to be connected in the inventive manner,

FIG. 2 shows a schematic diagram of a folded connection,

FIG. 3 shows a schematic diagram of a bonded connection,

FIG. 4 shows a schematic diagram of a bonded connection with a first fold and

FIG. 5 shows a schematic diagram of a bonded connection with a second fold.

Reference is made to FIGS. 1 to 5.

A dishwasher inner container 2 is illustrated, which is formed by joining together a base element serving as a base trough 6 and a container jacket 4. The container jacket 4 and base element 6 here can be made of stainless steel or plastic.

Both the container jacket 4 and the base element 6 have a connection region 8, 10, in which both the container jacket 4 and the base element 6 have correspondingly disposed interfaces 12, 14. The interfaces 12, 14 here are designed so that they are configured to establish a folded connection, when the container jacket 4 and the base element 6 are made of metal. The interfaces 12, 14 also allow a bonded connection to be established, when at least the container jacket 4 or the base element 6 is made of plastic.

When both the container jacket 4 and the base element 6 are made of stainless steel (see FIG. 2), a connection is established by folding. To this end the container jacket 4 has an interface 8 having a first fold 20 in the connection region 12, while the base element 6 has an interface 10 having a second fold 24 in the connection region 14, it being possible for these to be used to connect the container jacket 4 and base element 6 to one another in the known manner. The first fold 20 and the second fold 24 are also designed so that they also permit bonded connections to be established, as described below.

When however the container jacket 4 and base trough 6 are made of plastic, the base element 6 made of plastic (see FIG. 3) also has an interface 10 in the connection region 14, said interface 10 comprising a groove 12, which can be filled with a strand of bonding agent 26 before a bonded connection is established. A spring 16 corresponding to the groove 14 can be inserted into the groove 12 to establish a bonded connection, said spring 16 belonging to the interface 8 of a container jacket 4 made of plastic disposed in the region of the connection region 10. The spring 16 of the container jacket 4 made of plastic also has a second groove 22, which is disposed in the spring 16 and allows a bonded connection to be established with a second fold 24 in a base element 6 made of stainless steel, as described below.

However when the container jacket 4 is made of stainless steel and the base element 6 of plastic (see FIG. 4), the interface 8 of the container jacket 4 made of stainless steel comprising the first fold 20 is inserted into the groove 12 of the base element and can be bonded there.

However when the container jacket 4 is made of plastic and the base element 6 of stainless steel (see FIG. 5), the second groove 22 disposed in the spring 16 is filled with a strand of bonding agent 26 and the second fold 24 is then inserted into the second groove 22 and bonded there.

The inventive method thus allows the simple and easy joining together of components 4, 6, for example of a base trough 6 and a container jacket 4, in any material combination, if they are components 4, 6 made of plastic and stainless steel for example.

### LIST OF REFERENCE CHARACTERS

2 Dishwasher inner container
4 Container jacket
6 Base element
8 Interface
10 Interface
12 Connection region
14 Connection region
16 First groove
18 Spring
20 First fold
22 Second groove
24 Second fold
26 Bonding agent

1-13. (canceled)

14. A method for connecting at least two components, the at least two components made of one of same materials or different materials at least in connection regions of the at least two components, the method comprising:
providing the at least two components with at least one interface to connect the one of the same materials and the different materials;
bringing the at least two components together; and
connecting the at least two components.

15. The method of claim 14, wherein the at least two components comprise a base element and a container jacket for a dishwasher.

16. The method of claim 14, wherein the at least one interface connects the at least two components without connecting elements.

17. The method of claim 16, wherein the at least one interface establishes a material fit between the at least two components.

18. The method of claim 17, wherein the least one interface establishes a bonded connection between the at least two components.

19. The method of claim 14, wherein the at least one interface establishes a form fit between the at least two components.

20. The method of claim 19, wherein the at least one interface establishes a folded connection between the at least two components.

21. A component, comprising an interface to connect the component to a further component that is made of one of a same material as the component or a different material than the component.

22. The component of claim 21, wherein at least one interface is structured to connect the component to the further component without connecting elements.

23. The component of claim 22, wherein the at least one interface is structured to establish a material fit of the component with the further component.

24. The component of claim 23, wherein the at least one interface is structured to establish a bonded connection of the component to the further component.

25. The component of claim 21, wherein the at least one interface is structured to establish a form fit of the component with the further component.

26. The component of claim 25, wherein at least one interface is structured to establish a folded connection to the further component.

27. A water-bearing domestic appliance comprising a component that has an interface to connect the component to a further component made of one of a same material as the component or a different material than the component.

28. The water-bearing domestic appliance of claim 27, wherein the water-bearing domestic appliance is a dishwasher.
